(19) United States
(12) Patent Application Publication
(10) Pub. No.: US 2023/0187955 A1
(43) Pub. Date: Jun. 15, 2023

(54) Method for Operating a Storage System for Storing Electrical Energy, and Storage System

(71) Applicant: Siemens Aktiengesellschaft, München (DE)

(72) Inventors: Mandred Baldauf, Erlangen (DE); Barbara Schricker, Erlangen (DE)

(73) Assignee: Siemens Aktiengesellschaft, München (DE)

(21) Appl. No.: 17/925,815

(22) PCT Filed: May 26, 2021
(86) PCT No.: PCT/EP2021/064037

§ 371 Date: Nov. 16, 2022

(30) Foreign Application Priority Data
May 28, 2020 (DE) 10 2020 206 715.5
Jun. 26, 2020 (DE) 10 2020 207 968.4

(51) Int. Cl. H02J 7/00; H01M 10/48; H01M 10/44

(52) U.S. Cl. CPC H02J 7/0068; H01M 10/486; H01M 10/441; H02J 7/0013; H02J 7/007192; H01M 2010/4271

(57) ABSTRACT

Various embodiments include a method for operating a storage system with two battery storage units, each with two battery cells and a battery management system, and an energy management unit with a processor unit. The method may include: providing phase transition data of the cells and transmitting said data to the EMU; the battery management systems providing states of charge; querying an amount of energy take-up to be provided and/or an amount of energy discharge to be provided; ascertaining a distribution result among the battery storage units based on an optimization problem solved by optimizing a target function, and wherein the phase transition data, the state of charge, the amount of energy take-up, and/or the amount of energy discharge are incorporated as optimization parameters; and charging or discharging the battery storage units in accordance with the distribution result.

### CROSS-REFERENCE TO RELATED APPLICATIONS

This application is a U.S. National Stage Application of International Application No. PCT/EP2021/064037 filed May 26, 2021, which designates the United States of America, and claims priority to DE Application No. 10 2020 207 968.4 filed Jun. 26, 2020, and DE Application No. 10 2020 206 715.5 filed May 28, 2020, the contents of which are hereby incorporated by reference in their entirety.

### TECHNICAL FIELD

Lithium-ion rechargeable batteries, also referred to as lithium-ion batteries below, are used as energy stores in mobile and stationary applications on account of their high power density and energy density. In order to be able to operate these electrical energy stores safely, reliably and for as long as possible without maintenance, knowledge of critical operating states, in particular with respect to the state of charge and with respect to the state of health, that is as accurate as possible is necessary.

It is known that the state of health of a battery, in particular what are known as cyclic states of health, can be negatively affected in particular by high temperatures and rapid temperature changes, depending on the state of charge and the charging power and discharge power. Assessing the state of health of a battery is therefore complex. An assessment is therefore disadvantageously often very time-consuming. Furthermore, assumptions often have to be made to assess the aging, which disadvantageously render said assessment inaccurate. This disadvantageously results in battery stores having larger dimensions than is required by the immediate power environment, so as to be able to avoid high-power charging, in particular at low temperatures, and large temperature changes.

### SUMMARY

The teachings of the present disclosure describe methods and/or systems for operating a storage system for storing electrical energy and a storage system that minimizes the aging processes of the store and allows more accurate dimensioning of the store. As an example, some embodiments include a method for operating a storage system (1) for storing electrical energy, comprising: providing a battery store (2) comprising at least two battery storage units (5, 6), which comprise at least two battery cells and have a battery management system (8), providing an energy management unit (3) having a processor unit (4), providing phase transition data of the battery cells and transmitting said data to the energy management unit (3), the battery management systems (8) providing states of charge of the battery storage units (5, 6, 7), providing a query about an amount of energy take-up to be provided and/or an amount of energy discharge to be provided by an energy supply system (10) to the energy management unit (3), ascertaining, in a computer-aided manner, a distribution result of the amount of energy take-up and/or the amount of energy discharge among the battery storage units (5, 6) in the energy management unit (3) on the basis of a solution for an optimization problem, wherein the optimization problem is solved by means of an optimization of a target function, and wherein the phase transition data, the state of charge and the amount of energy take-up and/or the amount of energy discharge are incorporated as optimization parameters of the optimization problem, and charging or discharging the battery storage units (5, 6) in accordance with the distribution result.

In some embodiments, a minimization of the phase transitions of the battery cells of the battery storage unit (5, 6) is used as the target function.

In some embodiments, the optimization takes place in the energy management system (3) on the basis of the state of charge of the battery storage unit (5, 6, 7) and the phase transition data of the battery cells, and the number of phase transitions undergone in an individual battery storage unit (5, 6) is ascertained.

In some embodiments, the operating temperature of at least one battery cell is measured by means of a temperature measuring unit, and the operating temperature data are transmitted to the energy management system (3).

In some embodiments, the phase transition data are checked on the basis of the operating temperatures of the battery cells, and the phase transition data are adjusted depending on the checking result.

In some embodiments, a power output, a power supply, an initial temperature and/or the state of charge of the battery storage unit are jointly incorporated into the check of the phase transition data.

In some embodiments, the adjusted phase transition data are incorporated into the optimization problem as optimization parameters.

In some embodiments, data relating to the operating temperature, power output and/or power supply, initial temperature and/or the state of charge are preprocessed by means of filters, in particular in the energy management unit (3).

As another example, some embodiments include a storage system (1) for storing electrical energy, comprising: a battery store (2) having at least two battery storage units (5, 6), which have a battery management system (8), an energy management unit (3) having a processor unit (4) designed for storing phase transition data of the battery cell and designed for detecting states of charge of the battery storage units (5, 6, 7), provided by the respective battery management system (8), and designed for detecting an amount of energy take-up to be provided and/or an amount of energy discharge to be provided by an energy supply system (10), designed for detecting an amount of energy take-up to be provided and/or an amount of energy discharge to be provided by an energy supply system (10), designed for ascertaining, in a computer-aided manner, a distribution result of the amount of energy take-up and the amount of energy discharge among the battery storage units (5, 6) on the basis of a solution for an optimization problem, wherein the optimization problem is solved by means of an optimization of a target function, and wherein the phase transition data, the state of charge and the amount of energy take-up to be provided and/or the amount of energy discharge to be provided are incorporated as optimization parameters of the optimization problem, and wherein the battery storage units (5, 6) can be charged or discharged in accordance with the distribution result.

In some embodiments, the battery storage unit is a battery cell, a battery module (5) or a battery rack (6) or a container.

In some embodiments, at least one of the battery storage units (5, 6) is a lithium battery.

In some embodiments, at least one battery storage unit is a redox flow battery (7), a lead acid rechargeable battery, an electrolyzer or a supercapacitor.

### BRIEF DESCRIPTION OF THE DRAWINGS

Further features, properties and advantages of the teachings of the present disclosure result from the description that follows with reference to the accompanying figures. In the figures, in each case schematically:

FIG. 1 shows a storage system having a battery store and an energy management unit incorporating teachings of the present disclosure;

FIG. 2 shows an open-circuit voltage characteristic curve with a phase transition incorporating teachings of the present disclosure; and

FIG. 3 shows a method diagram for operating a storage system having a battery store and an energy management unit for storing electrical energy incorporating teachings of the present disclosure.

### DETAILED DESCRIPTION

Some embodiments of the teachings herein include a method for operating a storage system for storing electrical energy comprises a plurality of steps. The battery store has at least two battery storage units, which comprise at least two battery cells and a battery management system. There is an energy management unit having a processor unit. Phase transition data of the battery cells are provided and transmitted to the energy management unit. Furthermore, the battery management system provides a state of charge of the battery storage unit.

A query about an amount of energy take-up to be provided and/or an amount of energy discharge to be provided by an energy supply system is also provided to the energy management unit. A distribution result of the amount of energy take-up and/or the amount of energy discharge among the battery storage units is ascertained in a computer-aided manner in the energy management unit on the basis of a solution for an optimization problem. The optimization problem is solved by means of an optimization of a target function, wherein the phase transition data, the state of charge and the amount of energy take-up and/or the amount of energy discharge are incorporated as optimization parameters of the optimization problem. The battery storage units are then charged or discharged in accordance with the distribution result.

In some embodiments, a storage system for storing electrical energy comprises a battery store having at least two battery storage units, which have a battery management system. Said storage system furthermore comprises an energy management unit having a processor unit that is designed for storing phase transition data of the battery store and is designed for detecting a state of charge of the battery store. The state of charge of the battery store is provided by the battery management system. The energy management unit is furthermore designed for detecting an amount of energy take-up to be provided and/or an amount of energy discharge to be provided by an energy supply system. The energy management unit is furthermore designed to ascertain, in a computer-aided manner, a distribution result of the amount of energy take-up and the amount of energy discharge among the battery storage units. The computer-aided ascertaining occurs by solving an optimization problem, wherein the optimization problem is solved by optimizing a target function, and wherein the phase transition data, the state of charge and the amount of energy take-up to be provided and/or the amount of energy discharge to be provided are incorporated as optimization parameters of the optimization problem. The battery storage units are designed to be charged or discharged in accordance with the distribution result.

A phase transition means a change in a crystal lattice of the active materials, in particular in a graphite lattice into which lithium ions can be incorporated. These data are measured, in particular for the battery cell independently of the operation of the storage system, and then transmitted and provided to the energy management unit. In some embodiments, the phase transition data for defined battery stores can be taken from reference tables, databases or further literature references.

An energy management unit means a control unit that directly controls the battery storage units.

An energy supply system means an energy supply network. In particular, the energy supply system in this invention will also be understood to be an energy system, in other words to be an electrical interconnection of at least one load and/or at least one generator.

The input parameters (input data) are in particular also referred to as optimization parameters for solving the optimization problem. In particular, the phase transition data also represent optimization parameters in the context of the invention, since they are input parameters. However, in contrast to the state of charge and the amounts of energy, the phase transition data do not represent a variable during the optimization, since the phase transition data are physically substantiated, not optimizable, values.

Distributing the amounts of energy take-up or amounts of energy discharge to be provided allows the battery store to be operated taking into account the phase transition data, the state of charge and the amount of energy take-up to be provided and/or the amount of energy discharge to be provided in such a way that the amount of energy take-up and amount of energy discharge are reliably provided or taken up and the aging of the battery store is reduced in the process. This makes it possible to extend the service life of the storage units and to reduce the maintenance outlay of the battery storage units. This reduces the service life costs per amount of energy stored.

In some embodiments, a minimization of the phase transitions of the battery cells of the battery storage unit is used as the target function. In particular, the number of phase transitions for the individual battery cells is accordingly reduced. Depending on the state of charge of individual battery storage units, the amount of energy that is intended to be provided or is intended to be taken up is distributed among the battery storage units in such a way that the battery cells for which the phase transitions are critical undergo as few phase transitions as possible. This allows the amount of energy to be reliably taken up or provided and the aging of the individual battery cells to be minimized in the process. As a result of the reduced aging effects, the individual battery cells can be operated for longer, as a result of which maintenance intervals can become longer. Furthermore, the costs per amount of energy provided are reduced over the service life. It is only necessary to include the phase transition data in the optimization.

In some embodiments, the optimization takes place in the energy management system, wherein the number of phase transitions undergone in an individual battery storage unit is ascertained on the basis of the state of charge of the battery storage unit and the phase transition data of the battery cells. The number of phase transitions is therefore determined over the service life of a battery storage unit. It is thus possible to selectively operate those battery storage units that have undergone fewer phase transitions than other battery storage units. In some embodiments, the individual storage units may be operated such that the state of charge range in which the phase transitions occur is not passed through. In some embodiments, the system distributes an amount of energy to be provided or taken up among the entire storage unit in such a way that high states of charge are also possible. It is therefore possible to minimize overdimensioning of battery stores.

In some embodiments, the operating temperature of at least one battery cell is measured by means of a temperature measuring unit, and the operating temperature data are transmitted to the energy management system. In some embodiments, the operating temperature of individual battery cells is considered in the optimization problem, and therefore to additionally minimize the aging of the individual battery cells.

In some embodiments, the phase transition data are checked on the basis of the operating temperature data of the at least one battery cell, and the phase transition data are adjusted depending on the checking result. In some embodiments, in the energy management system, to carry out an adjustment of the known phase transition data with the aid of the behavior of the at least one battery cell in terms of the temperature, and to therefore recognize shifts in the phase transition data, in other words shifts in the critical state of charge range, and to provide them for the optimization. It is therefore possible to update the phase transition data over the service life of the battery store.

In some embodiments, a power output and/or a power supply, an initial temperature and/or the state of charge are jointly incorporated into the check of the phase transition data. In particular, temperature changes during operation of the battery store that do not represent any indication of a shift in the critical point can therefore advantageously be prevented from being incorrectly used for updating the phase transition data.

In some embodiments, the adjusted phase transition data are incorporated into the optimization problem as optimization parameters. It is therefore possible to optimize operation over the entire service life of the battery store in such a way as to involve the phase transition data that a battery cell has owing to its history. In some embodiments, it is therefore possible to minimize the aging depending on the aging of the at least one battery cell that has already occurred. This reduces the aging of the battery store further.

In some embodiments, data, in particular relating to the operating temperature, power output, power supply, initial temperature and/or state of charge, are preprocessed by using filters, in particular filter algorithms for cleaning up the data, in particular by means of low-pass filters. This preprocessing occurs in particular in the energy management unit. Unwanted noise is therefore advantageously not transmitted into the data during the measurements.

In some embodiments, the battery storage unit is a battery module or a battery rack or a container. A battery module comprises at least ten battery cells. At least two battery modules are arranged in a rack. In particular, at least one battery rack is arranged in a container. The amount of energy to be provided or to be taken up can also be distributed among different battery storage units. In other words, it is possible to combine a mixture of modules, racks and containers to form the battery store, and to distribute the amount of energy among these different storage levels. This advantageously increases the flexibility of the distribution, meaning that the number of phase transitions can be minimized and the aging can therefore be reduced.

In some embodiments, at least one of the battery storage units is a lithium-ion battery. Phase transitions take place in particular when the lithium is incorporated into a crystal lattice, in particular into a graphite crystal lattice. Phase transitions are therefore significant in particular for aging effects in lithium batteries. Minimization of the aging by optimizing phase transitions is therefore advantageously particularly effective for lithium batteries.

In some embodiments, in addition to the battery storage unit that is a lithium-ion battery, at least one battery storage unit is a redox flow battery, a lead acid rechargeable battery or a supercapacitor. The battery storage unit can also comprise a water electrolyzer with hydrogen stores or further storage devices for electrical energy. In other words, the storage unit in this case is a hybrid storage unit. In some embodiments, depending on the amount of energy to be provided or to be taken up, and depending on the phase transition data and the state of charge of the battery stores, for the energy management system to distribute the amounts of energy also among those battery storage units that can be operated independently of phase transition data. Frequent critical charging operations in the battery store, that is to say in particular charging operations in which a phase transition is exceeded, can therefore be avoided. The aging of the battery store is therefore advantageously minimized further.

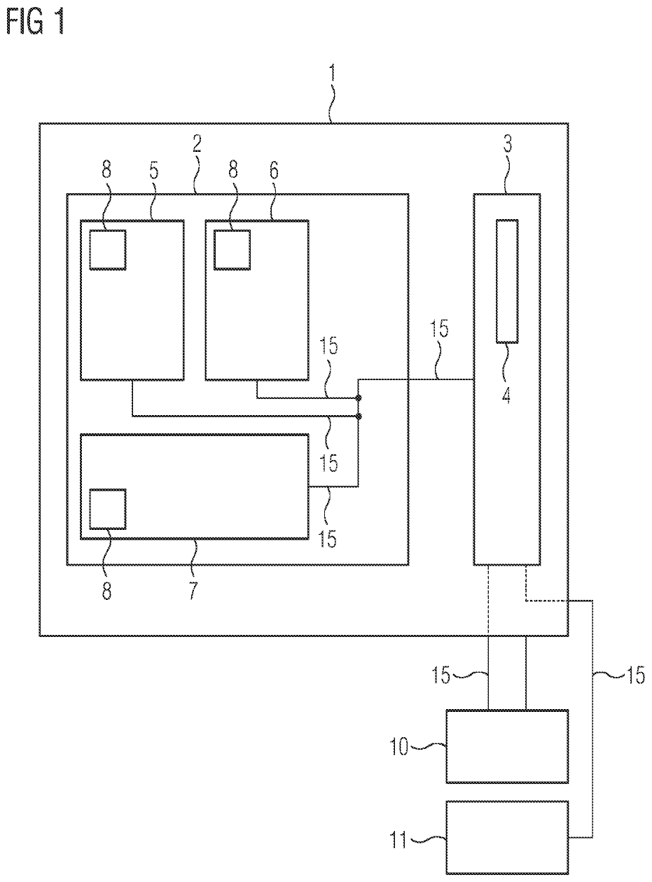

FIG. 1 shows a storage system 1 incorporating teachings of the present disclosure having a battery store 2 and an energy management unit 3. The battery store 2 comprises a battery module 5, a battery rack 6 and a redox flow battery 7. The battery module 5, the battery rack 6 and the redox flow battery each comprise a battery management system 8. The battery module 5 and the battery rack 6 comprise battery cells, which are lithium-ion battery cells. The battery management system 8 of the battery module 5, of the battery rack 6 and of the redox flow battery 7 in each case ascertains the state of charge of the corresponding unit and transmits this to the energy management unit 3. The energy management unit 3 comprises a processor unit 4. The energy management unit 3 is connected to the battery store 2 via a data transmission line 15.

FIG. 1 furthermore shows an energy supply system 10 and a phase transition database 11. In this example, the energy supply system 10 and the storage system 1 are considered to be separate energy subsystems that are electrically connected to one another. It is likewise possible for the storage system 1 to be integrated into the energy supply system 10. The phase transition database 11 is connected to the storage system 1 via a data transmission line 15. The energy supply system 10 is also connected to the storage system 1 via a data transmission line 15.

States of charge of the battery storage units are provided to the energy management unit 3. In this example, battery storage units are understood to be the battery module 5, the battery rack 6 and the redox flow battery 7. In this case, provided means that states of charge are ascertained, on the one hand, by the respective battery management system 8. The battery management systems 8 in turn then transmit these data to the energy management unit 3. Therefore, in this example, the provision comprises both the detection and the transmission of the states of charge.

Furthermore, phase transition data are provided to the energy management unit 3 from the phase transition database 11. It is the case in this example that the provision describes a transmission of the phase transition data from the phase transition database 11 to the energy management unit 3. In some embodiments, phase transition data are detected by measurement, in particular in a laboratory, and are then transmitted to the energy management unit 3.

Furthermore, a query about an amount of energy take-up to be provided and/or an amount of energy discharge to be provided by the energy supply system 10 is transmitted or provided to the energy management unit 3 via the data transmission line 15. A distribution result of the queried amount of energy take-up and/or the amount of energy discharge among the individual battery storage units is then ascertained in a computer-aided manner in the energy management unit 3. The ascertaining occurs by solving an optimization problem. In this example, a target function of the optimization problem is a minimization of the phase transitions of the battery module 5 and the battery rack 6.

In this example, a query about an amount of energy discharge to be provided is made by the energy supply system 10. In particular, there is an energy requirement amounting to 20 kWh that is intended to be provided by the storage system 1. The state of charge of the battery module 5 is above the critical phase transition. The state of charge of the battery rack 6 is below the critical phase transition. Both the battery module 5 and the battery rack 6 comprise battery cells based on lithium-ion rechargeable batteries. In this case, a phase transition is understood to mean a change in the crystal lattice of an active material, in this example of a carrier material, in particular of a graphite layer, into which lithium ions are incorporated. This phase transition is in particular dependent on the state of charge of the battery cell.

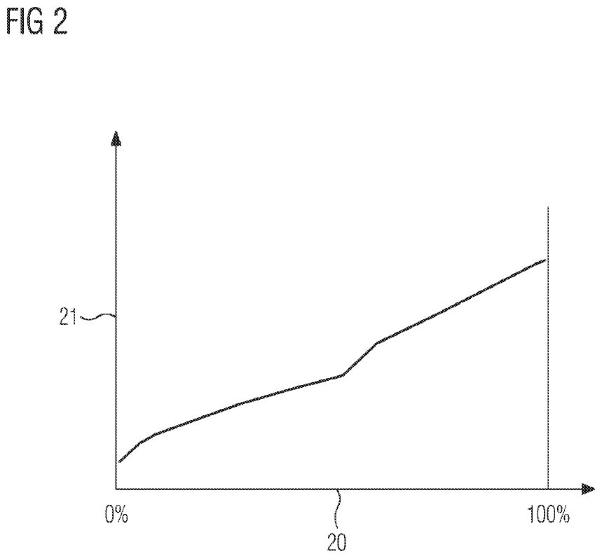

FIG. 2 shows an open-circuit voltage characteristic curve 21 that has been plotted against a state of charge 20. A change in the gradient can be seen in a state of charge range between 40% and 70%. In particular, this gradient change is characteristic of a phase transition. The state of charge of the redox flow battery 7 is independent of a phase transition.

An optimum distribution of the amount of energy required would then be one in which the number of phase transitions in the battery module 5 and in the battery rack 6 is not increased, but the queried amount of energy discharge is provided. A possible solution for the optimization problem would then be that the amount of energy is only drawn from the battery rack 6 and the redox flow battery 7 in order to avoid a phase transition in the battery module 5 for this query regarding the provision of the amount of energy. In other words, a distribution result is ascertained, which carries out a distribution of the amount of energy to be provided among the battery rack 6 and the redox flow battery 7. The battery rack 6 and the redox flow battery 7 are therefore discharged.

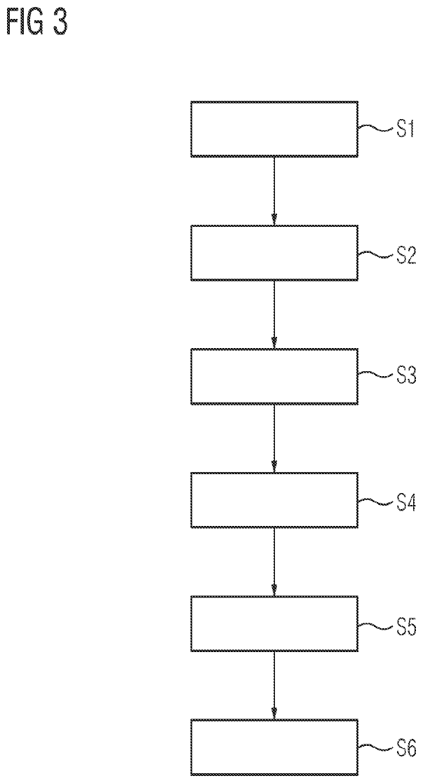

FIG. 3 shows a method diagram for operating a storage system 1 for storing electrical energy incorporating teachings of the present disclosure. In a first step S1, the battery store 2 is provided, wherein the battery store 2 comprises battery storage units, in particular a battery module 5, a battery rack 6 and a redox flow battery 7. In a second step S2, an energy management unit 3 is provided. In a third step S3, phase transition data of the battery cells are provided and transmitted to the energy management unit 3. In a fourth step S4, a query about an amount of energy take-up to be provided and/or an amount of energy discharge to be provided is transmitted or provided to the energy management unit 3. In a fifth step S5, a distribution result of the amount of energy take-up and/or the amount of energy discharge among the battery storage units is ascertained in the energy management unit. The ascertaining occurs on the basis of the solution for an optimization problem, wherein the optimization problem is solved by means of an optimization of a target function. The phase transition data, the state of charge of the battery storage units and the amount of energy take-up and/or the amount of energy discharge are incorporated as optimization parameters of the optimization problem. In a sixth step S6, the battery storage units are charged or discharged in accordance with the distribution result.

### LIST OF REFERENCE SIGNS

1 Storage system
2 Battery store
3 Energy management unit
4 Processor unit
5 Battery module
6 Battery rack
7 Redox flow battery
8 Battery management system
10 Energy supply system
11 Phase transition database
15 Data transmission line
20 State of charge
21 Open-circuit voltage of a battery cell
S1 Providing the battery store
S2 Providing an energy management unit
S3 The battery management system providing a state of charge of the battery storage units
S4 Providing a query about an amount of energy take-up to be provided and/or an amount of energy discharge to be provided by an energy supply system to the energy management unit
S5 Ascertaining, in a computer-aided manner, a distribution result of the amount of energy take-up and/or the amount of energy discharge among the battery storage units in the energy management unit
S6 Charging or discharging the battery storage units in accordance with the distribution result

What is claimed is:

1. A method for operating a storage system for electrical energy,
the storage system including a battery store with two battery storage units, each with at least two battery cells and a battery management system, and
an energy management unit with a processor unit, the method comprising:
providing phase transition data of the battery cells and transmitting said data to the energy management unit;
the battery management systems providing states of charge of the battery storage units;
querying an amount of energy take-up to be provided and/or an amount of energy discharge to be provided by an energy supply system to the energy management unit;
ascertaining a distribution result of the amount of energy take-up and/or the amount of energy discharge optimizing a target function, and wherein the phase transition data, the state of charge, the amount of energy take-up, and/or the amount of energy discharge are incorporated as optimization parameters of the optimization problem; and
charging or discharging the battery storage units in accordance with the distribution result.

2. The method as claimed in claim 1, further comprising using a minimization of the phase transitions of the battery cells of the battery storage unit as the target function.

3. The method as claimed in claim 1, wherein the optimization takes place in the energy management system on the basis of the state of charge of the battery storage unit and the phase transition data of the battery cells; and
ascertaining a number of phase transitions undergone in an individual battery storage unit.

4. The method as claimed in claim 1, further comprising:
measuring the operating temperature of at least one battery cell using a temperature measuring unit; and
transmitting the operating temperature data to the energy management system.

5. The method as claimed in claim 4, further comprising:
checking the phase transition data on the basis of the operating temperatures of the battery cells; and
adjusting the phase transition data depending on the checking result.

6. The method as claimed in claim 5, wherein the phase transition data includes a power output, a power supply, an initial temperature, and/or the state of charge of the battery storage unit.

7. The method as claimed in claim 5, further comprising incorporating the adjusted phase transition data into the optimization problem as optimization parameters.

8. The method as claimed in claim 4, further comprising filtering data relating to the operating temperature, power output and/or power supply, initial temperature and/or the state of charge.

9. A storage system for storing electrical energy, the system comprising:
a battery store having at least two battery storage units with a battery management system;
an energy management unit having a processor unit for storing phase transition data of the battery cell and for detecting states of charge of the battery storage units, provided by the respective battery management system, and designed for detecting an amount of energy take-up to be provided and/or an amount of energy discharge to be provided by an energy supply system, designed for detecting an amount of energy take-up to be provided and/or an amount of energy discharge to be provided by an energy supply system, designed for ascertaining, in a computer-aided manner, a distribution result of the amount of energy take-up and the amount of energy discharge among the battery storage units on the basis of a solution for an optimization problem, wherein the optimization problem is solved by means of an optimization of a target function, and wherein the phase transition data, the state of charge and the amount of energy take-up to be provided and/or the amount of energy discharge to be provided are incorporated as optimization parameters of the optimization problem, and wherein the battery storage units can be charged or discharged in accordance with the distribution result.

10. The storage system as claimed in claim 9, wherein the battery storage unit comprises a battery cell, a battery module, a battery rack, or a container.

11. The storage system as claimed in claim 9, wherein at least one of the battery storage units comprises a lithium battery.

12. The storage system as claimed in claim 11, wherein at least one battery storage unit comprises a redox flow battery, a lead acid rechargeable battery, an electrolyzer, or a supercapacitor.
